(19) United States
(12) Patent Application Publication
(10) Pub. No.: US 2006/0285533 A1
(43) Pub. Date: Dec. 21, 2006

(54) Method, system, and article for telephone notification of an online status of a user

(75) Inventors: Abha S. Divine, Austin, TX (US); Michael F. Grannan, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/156,240

(22) Filed: Jun. 17, 2005

(51) Int. Cl. H04L 12/66

(52) U.S. Cl. 370/352

(57) ABSTRACT

Various embodiments of the present invention beneficially allow greater flexibility in the choice of alert modes for an electronic calendar system. Email messages, SMS, EMS or MMS messages, telephone calls and the like are used to replace or supplement the alerts generated by the electronic calendar. In various embodiments, the user is allowed to select the alert mode as well as alert features and priorities in addition to escalation procedures so that appropriate alert messages are generated at the appropriate times and alert messages have a greater chance of reaching the user. The use of the telephone ring tone, optionally with a distinctive ring, also provides greater notice to a user who is more attuned to reacting to a ringing telephone.

### FIELD OF THE DISCLOSURE

The present invention relates to methods, systems, and articles for notifying a user of calendar event.

### BACKGROUND

With the increased use of various calendar and personal digital assistant (PDA) tools, schedule notifications or reminders have also increased in use. However, such systems rely on the host device, such as the computer or PDA to issue the alert—for example, preset reminder messages that are prompted to a computer screen by Microsoft Outlook or other similar calendar systems. While this is useful at times when the user is in close proximity to the PDA or computer, it does not fully integrate a person's notification of calendar and schedule in environments away from these devices.

In addition, the alert messages in present systems generate audio alert signals that can be easily confused with other forms of computer alerts, such as incoming mail alerts that may not be of the same urgent nature.

### BRIEF DESCRIPTION OF THE DRAWINGS

The invention is pointed out with particularity in the appended claims. However, other features of the invention will become more apparent and the invention may be best understood by referring to the following detailed description in conjunction with the accompanying drawings in which:

FIG. 1 is a block diagram representation in accordance with various embodiments of the present invention;

FIG. 2 is a flow chart representation in accordance with various embodiments of the present invention;

FIG. 3 is a flow chart representation in accordance with various embodiments of the present invention;

FIG. 4 is a flow chart representation in accordance with various embodiments of the present invention;

FIG. 5 is a flow chart representation in accordance with various embodiments of the present invention;

FIG. 6 presents a pictorial view of a system in accordance with various embodiments of the present invention;

FIG. 7 is a flow chart representation in accordance with various embodiments of the present invention;

FIG. 8 is a pictorial representation of an example calendar event table in accordance with various embodiments of the present invention;

FIG. 9 is a flowchart representation in accordance with various embodiments of the present invention;

FIG. 10 is a pictorial representation of an example wireless device in accordance with various embodiments of the present invention; and

FIG. 11 is a flow chart representation in accordance with various embodiments of the present invention.

### DETAILED DESCRIPTION OF THE DRAWINGS

Various embodiments of the present invention beneficially allow greater flexibility in the choice of alert modes for an electronic calendar system. Email messages, SMS messages, telephone calls and the like are used to replace or supplement the alerts generated by the electronic calendar. In various embodiments, the user is allowed to select the alert mode as well as alert features and priorities in addition to escalation procedures so that appropriate alert messages are generated at the appropriate times and alert messages have a greater chance of reaching the user. The use of the telephone ring tone, optionally with a distinctive ring, also provides greater notice to a user who is more attuned to reacting to a ringing telephone.

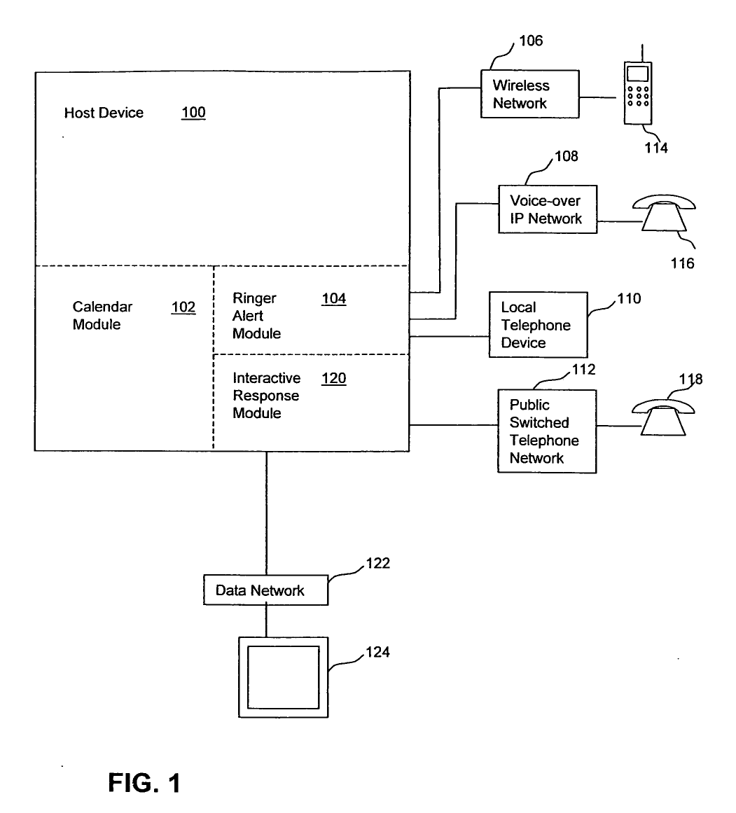

FIG. 1 is a block diagram representation in accordance with various embodiments of the present invention. Host device 100 includes a calendar module 102 and a ringer alert module 104 that is in communication with one or more of a wireless network 106 and wireless device 114, a voice-over-Internet-Protocol (VOIP) network 108 in communication with telephony device 116, a local telephony device 110 connected directly to host device 100, a public switched telephone network 112 in communication with telephony device 118, and a data network 122 in communication with data device 124.

The ringer alert module 104 optionally includes an interactive response module 120 for communication with users of remote telephony devices 114, 116, 118 and local telephony device 110. In various embodiments this interactive response module is an interactive voice response (IVR) device that is capable of playing audio messages comprising either a pre-recorded spoken message, a synthesized speech message, or a combination thereof and that includes a storage device for storing notifications and creating notification messages. The IVR is further capable of receiving responses in the form of either voice or DTMF signals from remote users. In alternative embodiments, interactive response module 120 can provide messages and can receive responses including text, audio, and video or some combination thereof using email messages, short messaging service (SMS), enhanced messaging service (EMS), or multi-media messaging service (MMS) formats used commonly in various wireless services or other message services.

In various embodiments, host device 100 can be a computer, a digital assistant, such as a personal digital assistant, a cellular telephone, or other device that is capable of hosting the electronic calendar module 102 and ringer alert module 104.

The calendar module 102, in a particular embodiment, is a software module running on a processor that performs the functions of an electronic calendar such as Microsoft Outlook. In operation, calendar module can accept data from a user to set a plurality of calendar events including calendar reminder events and associated calendar event data. In a particular embodiment, calendar event data includes such information as the date, time, place, call-in number, conference bridge information, an IP address or web address corresponding to an electronic meeting using an application such as Microsoft NetMeeting, a duration, meeting participants and contact information for the participants, an importance factor, such as low, medium or high, and the time to the beginning of the event.

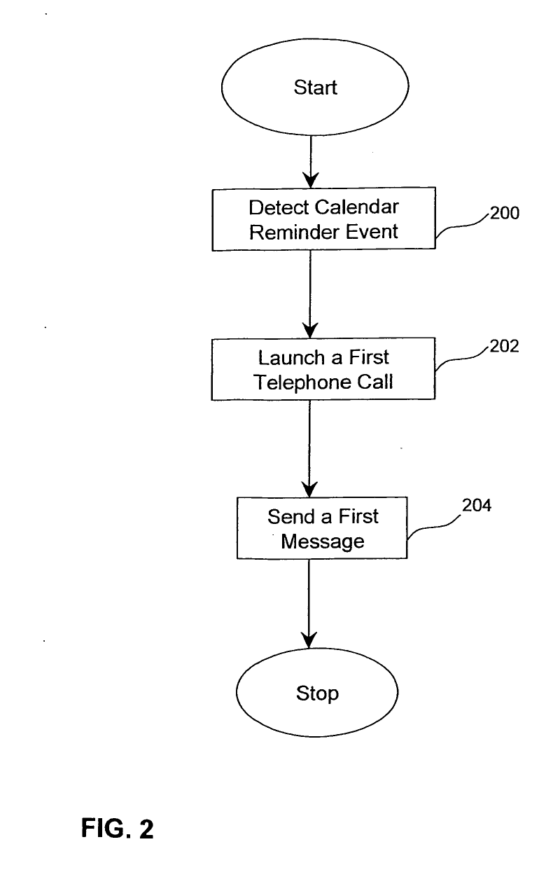

FIG. 2 is a flow chart representation in accordance with various embodiments of the present invention. In particular, a method is presented for use with an electronic calendar for issuing alerts such as calendar module 102 of host device 100. The method begins in step 200 by detecting a calendar reminder event, the calendar reminder event having associated calendar event data. The method proceeds to step 202 by launching a first telephone call to a first telephone number associated with the calendar reminder event in response to said detecting, the first telephone number associated with a first called party. In step 204, a first message is sent within the first telephone call.

By way of example, the electronic calendar includes a calendar event as follows.

Subject: Meeting with Staff

Date: January 1st, 2002

Time: 3:30 pm-4:00 pm

In setting up the calendar event, the user of the electronic calendar sets a reminder option corresponding to this particular calendar event, and globally enables the notification feature of the electronic calendar. The user further either specifies a reminder time (such as 15 minutes prior to the event) or relies upon a default setting for this parameter.

When the electronic calendar, using an internal clock, determines that the actual time is 15 minutes prior to the scheduled starting time of the event, a calendar reminder event is detected. The method proceeds to initiate an alert by launching a telephone call to a telephone number stored in the host device 104, either specific to this particular calendar event or from some general list of telephone numbers and instructions. In various embodiments, a telephone call is placed to the user to inform him or her of the upcoming calendar event. When the user picks up the call, a message is played that informs the user of the nature of the call and optionally provides selected data from the calendar event data associated with the calendar event. Again, by way of example, the message may say, “This is the calendar notification system; your MEETING WITH STAFF is scheduled to begin in 14 minutes”.

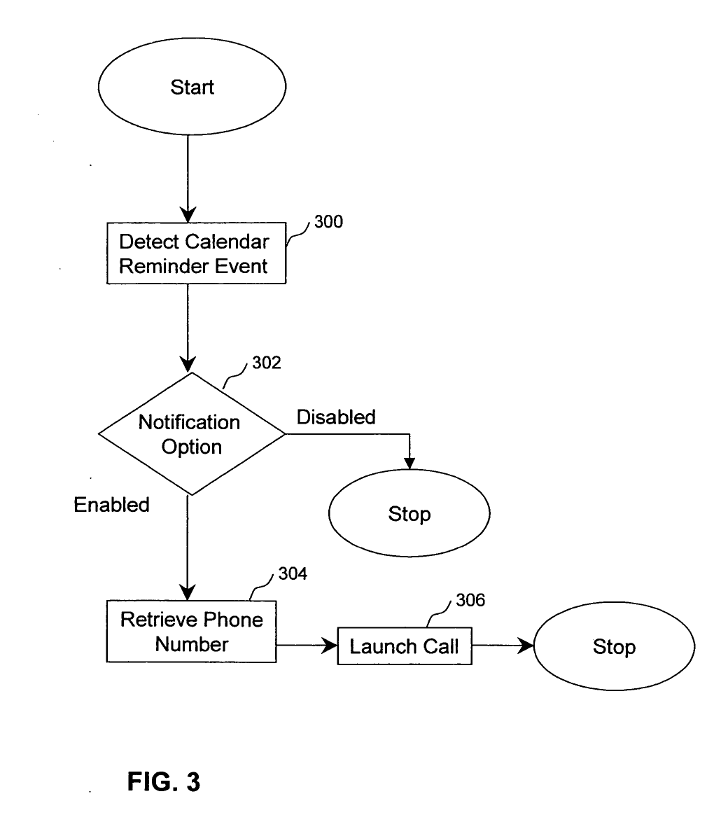

FIG. 3 is a flow chart representation in accordance with various embodiments of the present invention. In particular, a method is presented that introduces an option to enable notifications. In addition, the method introduces a feature for retrieving a telephone number that may be specific to a particular calendar event. In step 300, a calendar event is detected. In step 302, the method determines whether the user has enabled the notification option. In one embodiment, the notification option can be enabled or disabled for all notifications. In this fashion, when the user wishes not to be disturbed, she can turn off the notification feature for a period of time. Alternatively, or in addition, the user may select for a particular event whether to enable or disable a particular notification option. This information can be recorded and stored in conjunction with the other calendar event data.

If the notification option is disabled, either globally or for a particular event, the notification is suspended. If, however, the notification option is enabled, the method proceeds to step 304 where a telephone number is retrieved and to step 306 where a telephone call is launched.

As in the case of the notification options, the telephone number used for notifications can be either a general number set in conjunction with the notification option itself, or a telephone number that is specific to a particular calendar event. By way of example, a user may select her office telephone number as a general number. When a calendar event occurs the office telephone is called or rung. However, if the user sets up several appointments out of the office, she may wish to set her cellular telephone as the notification number because she knows that she will not be at her desk at the time that the notification will be issued. This information can be recorded and stored in conjunction with the other calendar event data.

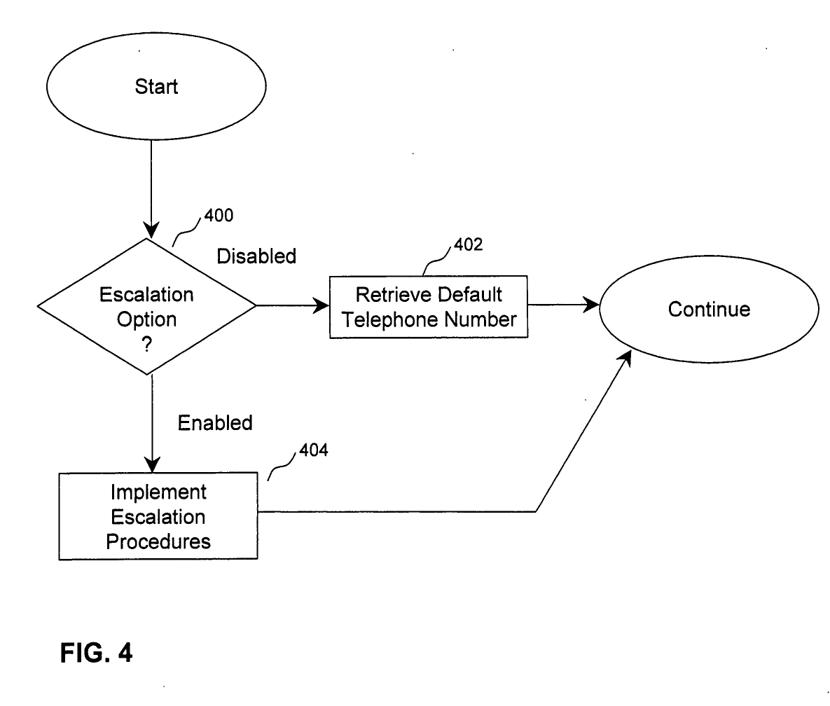

FIG. 4 is a flow chart representation in accordance with various embodiments of the present invention. A method is presented for implementing the step of retrieving in accordance with various implementations of step 304 in FIG. 3. In particular, the step of retrieving, in this case, is implemented in conjunction with various escalation options and procedures. The method begins in step 400 by determining if escalation options have been enabled by the user. If not, the method retrieves a default telephone number in step 402. If escalation options have been enabled by the user, the method proceeds to step 404 to implement those implementation procedures. In either case the method continues by launching a call or sending a notification message in accordance with the various embodiments of the present invention.

In a particular embodiment, the escalation procedures comprise an ordered list of escalation events and a set of conditions for proceeding to the next escalation event. An example of such a list follows:

| Escalation Event | Escalation Conditions |
|---|---|
| 1. Display pop-up screen | Default |
| 2. Send email | No response from user to pop-up |
| | screen within 5 minutes or |
| | response from user to increase to |
| | next escalation level |
| 3. Call office telephone | No response to email within 3 |
| | minutes or response from user to |
| | increase to next escalation level |
| 4. Call cell phone | No response to telephone call to |
| | office or calendar event data |
| | indicates “high priority” or |
| | response from user to increase to |
| | next escalation level |

In this fashion, as time draws nearer to the time of the event, the notification procedures escalate to be more intrusive to the user—increasing the probability to reach the user and obtain her attention.

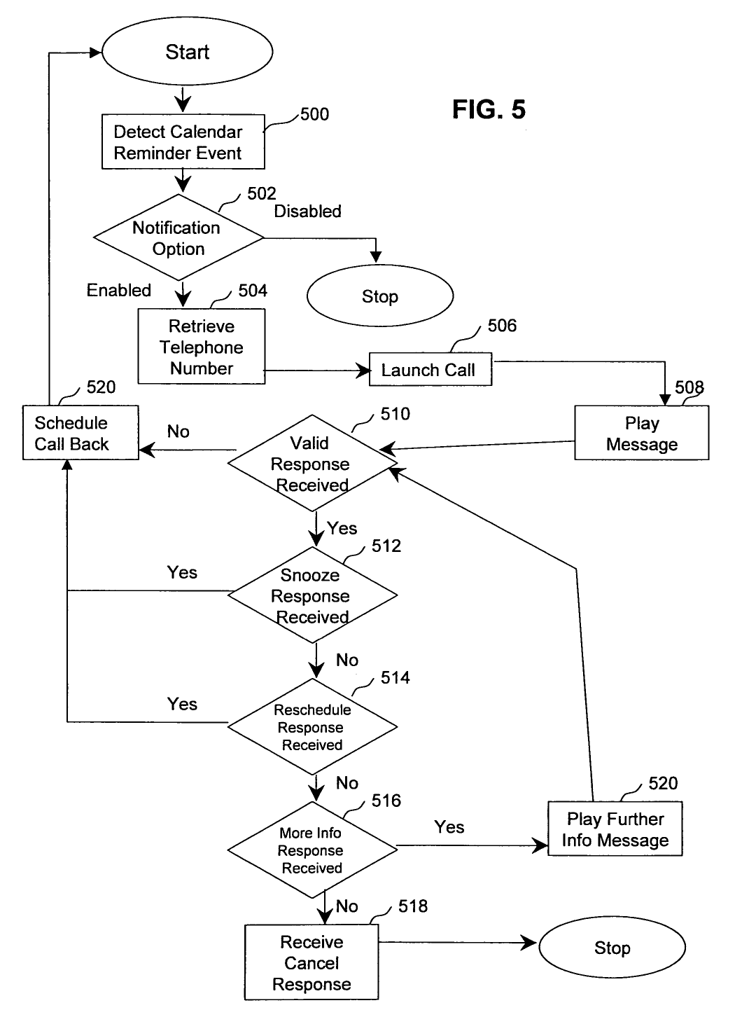

FIG. 5 is a flow chart representation in accordance with various embodiments of the present invention. This method presents and illustrates optional user response features. In step 500 a calendar event is detected. In step 502, the method determines whether the user has enabled the notification option. If the notification option is disabled, either globally or for a particular event, the notification is suspended. If, however, the notification option is enabled, the method proceeds to step 504 where a telephone number is retrieved and to step 506 where a telephone call is launched.

In step 508 the method proceeds by sending an audio message within the first telephone call. The message optionally includes one or more of the event data and prompts the called party to generate a response. This message serves to inform the called party of the purpose of the call and to determine if an action should be taken. In a particular embodiment, possible actions include:

Possible Response Actions

Cancel further notifications for this calendar event
Initiate a snooze feature
Reschedule the notification for a later time
Receive more information about the calendar event

These possible actions are prompted to the called party in the content of the audio message, each with a corresponding response of the called party to invoke the action. For instance: “to cancel further notifications for this calendar event, press or say 1”; “to initiate a snooze feature, press or say 2”; “to reschedule the notification for a later time, press or say 3”; and “to receive more information about the calendar event, press or say 4”.

In step 510 the method determines if a valid response is received. If no valid response is received, the method proceeds to step 520 to schedule a callback at a predetermined call-back interval, such as five minutes. If a snooze response is received, as shown in step 512, a callback is scheduled in step 520 at some predetermined snooze time, such as five minutes prior to the calendar event. If a reschedule response is received, the called party is prompted to select a reschedule time, such as 5, 10, 15, 30 or 60 minutes later and, in step 520 the call-back is scheduled for the selected time. If a response is received indicating that the called party wishes to receive more information about the calendar event, further calendar event data is converted to audio and played to the called party. If a response is received from the user indicating that further notification should be canceled for this calendar event, as shown in step 518, the method ends without scheduling additional calls or notices.

In an alternative embodiment, the called party is prompted to select additional types of calendar event data, and only those selected portions of the calendar event data are converted to audio and played to the called party. For example, if the called party selects the “call-in number”, the interactive response unit 120 of host 100 could play an audio message that says, “the call-in number is 512-555-1234”.

In further alternative embodiments, additional prompts may be issued and responses received. A called party can be prompted to proceed to a next escalation event. If the appropriate response is received, the next escalation event can be selected and initiated. A called party can also be prompted to initiate a quiet mode. If the appropriate response is received, the notification can be canceled and the notification option can be disabled.

In an additional embodiment, if a response is received that does not correspond to any of the valid responses, the method proceeds to return to re-prompt the called party with instructions on the valid prompts.

In accordance with a particular embodiment, sending a telephone alert includes a determination of an alert message that was delivered to a person, as opposed to an answering machine or voicemail. When a telephone call containing the alert message is picked up, a message is played that informs the user of the nature of the call and optionally solicits the user to provide a response in order to continue. By way of example, the message may say, “This is the calendar notification system; please push or say ‘one’ to continue”. In this fashion, the system is able to determine if a person has answered the telephone. In accordance with an embodiment used in conjunction with the implementation of escalation procedures disclosed above, the system may automatically proceed to the next escalation level if it determines that an answering machine or voicemail has picked up the call.

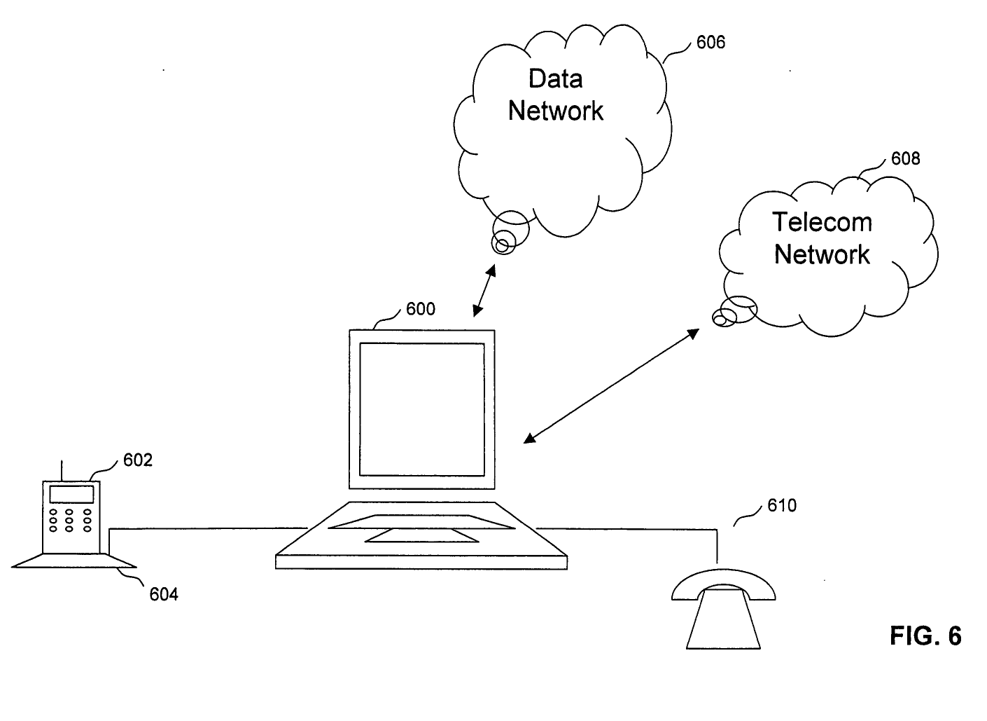

FIG. 6 presents a pictorial view of a system in accordance with various embodiments of the present invention. PDA 602 is connected to computer 600 via interface cradle 604. Both the computer 600 and the PDA 602 include an electronic calendar that implements calendar module 102. The electronic calendar from the PDA 602 is synchronized with electronic calendar of the computer 600, and vice versa, when the PDA 602 is placed in interface cradle 604.

In one embodiment, the functions of host device are performed by PDA 602. In an alternative embodiment, computer 600 performs the functions of host device 100. In either case a notification message can be launched through either telecom network 608 to a remote user on either a wireline, wireless, or VOIP telephone. For example, the telecom network 608 may comprise either a public switched telephone network, a private telephone network, a digital subscriber line access to a computer network, cable-television-based access to a computer network, satellite-based access to a computer network, a cellular network, a paging network, a PCS network, a WiFi network, a WLAN, or any combination thereof.

In addition, a notification message can be directly sent to local telephone 610 functioning as local telephony device 110. A ring signal is supplied to telephone 610 and, when the user picks up or the call is directed to an answering machine or voicemail, a message is played that informs the user of the nature of the call and optionally provides selected data from the calendar event data associated with the calendar event.

In a further example, a notification message can be launched through data network 606 to remote users of a laptop, a computer, a PDA, an automobile to a wired or wireless email account or via an SMS, an EMS or MMS message to a wireless device or to any other device with messaging capability over a data network. Computer 600 can be connected to data network 606 by means of a dial-out modem, a network interface, a cable modem and cable line, a network interface and digital subscriber line. Data network 606 can comprise a local area network, wide area network, metropolitan area network, private data network, virtual private data network, or public data network such as the Internet or wireless network.

By way of example, the computer 600 communicates a text, audio video or multimedia message to the user. The message may optionally include one or more of the event data and further may prompt the called party to generate a response. This message serves to inform the called party of the purpose of the call and to determine if an action should be taken.

Possible actions include:

Possible Response Actions

Cancel further notifications for this calendar event
Initiate a snooze feature
Reschedule the notification for a later time
Receive more information about the calendar event

These possible actions are prompted to the remote user, each with a corresponding response of the called party to invoke the action. For instance: “to cancel further notifications for this calendar event, press or say 1”; “to initiate a snooze feature, press or say 2”; “to reschedule the notification for a later time, press or say 3”; and “to receive more information about the calendar event, press or say 4”.

If no valid response is received, the method proceeds to schedule a further notification at a predetermined interval, such as five minutes. If a snooze response is received, a further notification is scheduled at some predetermined snooze time, such as five minutes prior to the calendar event. If a reschedule response is received, the remote user is prompted to select a reschedule time, such as 5, 10, 15, 30 or 60 minutes later and further notification is scheduled for the selected time. If a response is received indicating that the remote user wishes to receive more information about the calendar event, further calendar event data is transmitted to the remote user. If a response is received from the user indicating that further notification should be canceled for this calendar event, the method ends without scheduling additional notices.

In a further embodiment, the user is presented with the option of generating a notification to other users, such as other meeting participants or others. If selected, the system would initiate an alert message to any or all such other users, as selected by the user, or as indicated in the calendar event data. Such calendar alerts can then be issued in a manner consistent with the other calendar alerts disclosed herein.

In an alternative embodiment, the remote user is prompted to select additional types of calendar event data, and only those selected portions of the calendar event data are transmitted to the called party. For example, if the called party selects the “call-in number”, the interactive response unit 120 of host 100 could transmit, “the call-in number is 512-555-1234”. Further, the user may chose to automatically dial the call-in number to connect to the conference bridge, via a separate call, a three way call, or via a call conferencing feature supported by a user's telephone service.

In further alternative embodiments, additional prompts may be issued and responses received. A remote user can be prompted to proceed to the next escalation event. If the appropriate response is received, the next escalation event can be selected and initiated. A remote user can be prompted to initiate a quiet mode. If the appropriate response is received, the notification can be canceled and the notification option can be disabled.

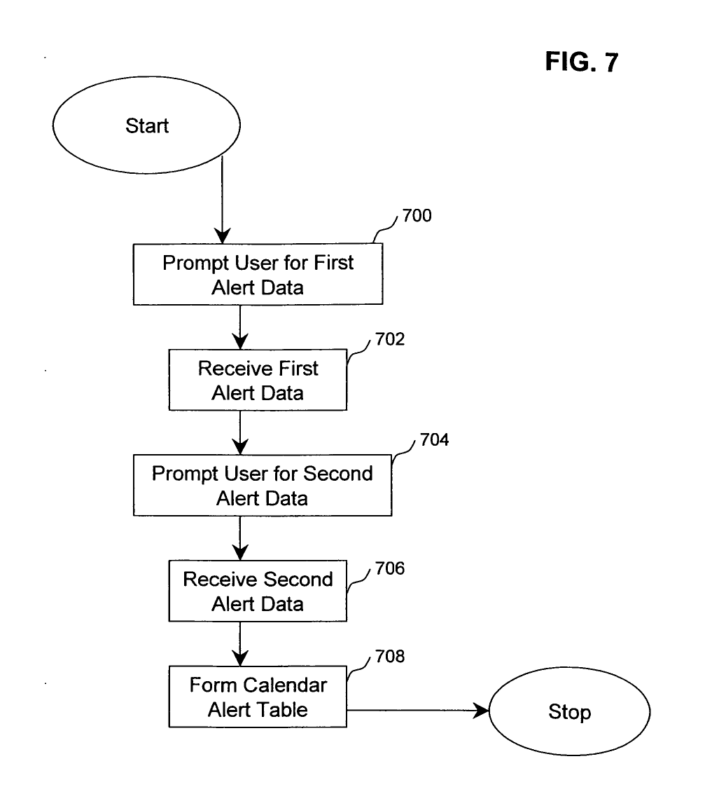

FIG. 7 is a flow chart representation in accordance with various embodiments of the present invention. A method of creating a calendar alert table for use with an electronic calendar is presented. The method begins in step 700 by prompting a user to enter first alert data and receiving the first alert data from the user in step 702. In step 704, the user is prompted to enter second alert data and the second alert data is received from the user in step 706. In step 708, a calendar alert table is formed from the received first alert data and the received second alert data, wherein, the calendar alert table is stored and accessible by the electronic calendar for generating at least one calendar alert in response to a calendar reminder event.

Initially, and unless and until the user sets up the calendar alert table, various entries of the calendar alert table take on one or more default settings. In a further embodiment, these default settings are derived from another account, or from personalized data corresponding to the users account.

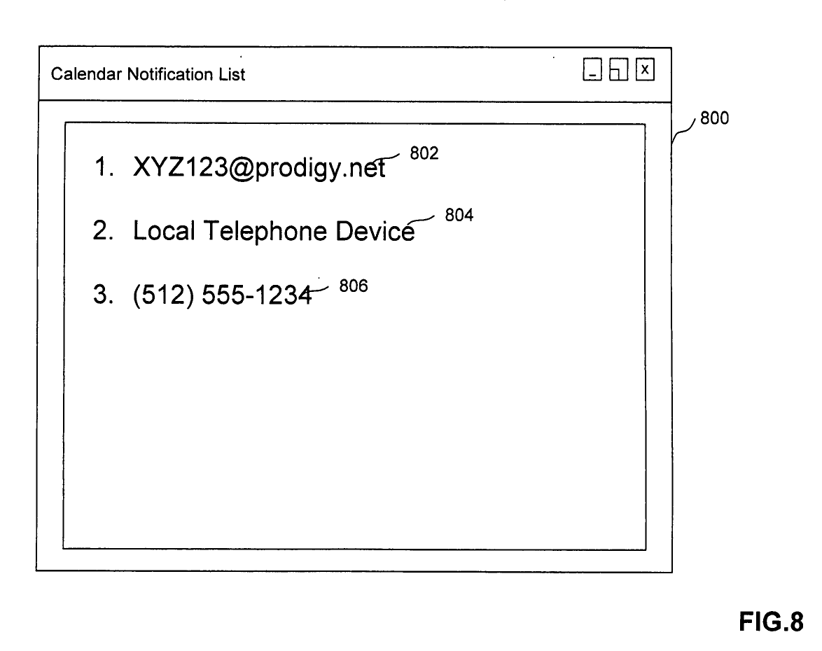

FIG. 8 is a pictorial representation of an example calendar event table in accordance with various embodiments of the present invention. In particular, calendar event table 800 is presented as a frame in a screen display of host device 100. It includes alert data sets, email address 802, local telephony device designator 804, and telephone number 806 that correspond to various alert options. In a particular embodiment, these alert options correspond to escalation events that, in combination with escalation conditions selected by the user, comprise the basis for escalation procedures. In an alternative embodiment, upon selection by the user, two or more of the alert options may be implemented simultaneously so that, for example, a calendar alert message can be sent to an email address, local telephony device, and a called party simultaneously.

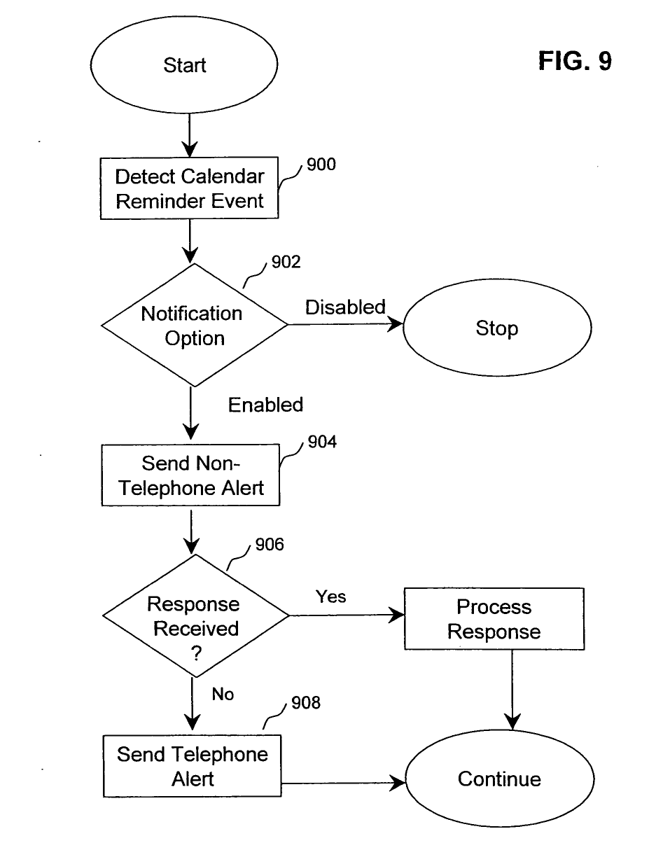

FIG. 9 is a flow chart representation in accordance with various embodiments of the present invention. In particular, this method presents a particular escalation procedure where a non-telephonic alert precedes the use of a telephonic alert. In step 900, a calendar event is detected. In step 902, the method determines whether the user has enabled the notification option. If the notification option is disabled, either globally or for a particular event, the notification is suspended. If, however, the notification option is enabled, the method proceeds to step 904 where a non-telephonic alert is sent. This non-telephonic alert may be a pop-up screen on the host device 100, an email alert, SMS, EMS or MMS message or other non-telephonic message. In each case, the non-telephonic alert prompts the user to respond by one or more of the following:

Example Responses

Cancel further notifications for this calendar event.
Initiate a snooze feature
Reschedule the notification for a later time
Receive more information about the calendar event
Select additional types of calendar event data
Proceed to the next escalation event
Initiate a quiet mode

If a valid response is received, the method proceeds to process that response in a manner as previously discussed. If none of the above options are selected and no response is received as shown in step 906, a telephonic alert is sent, at 908, and the method continues.

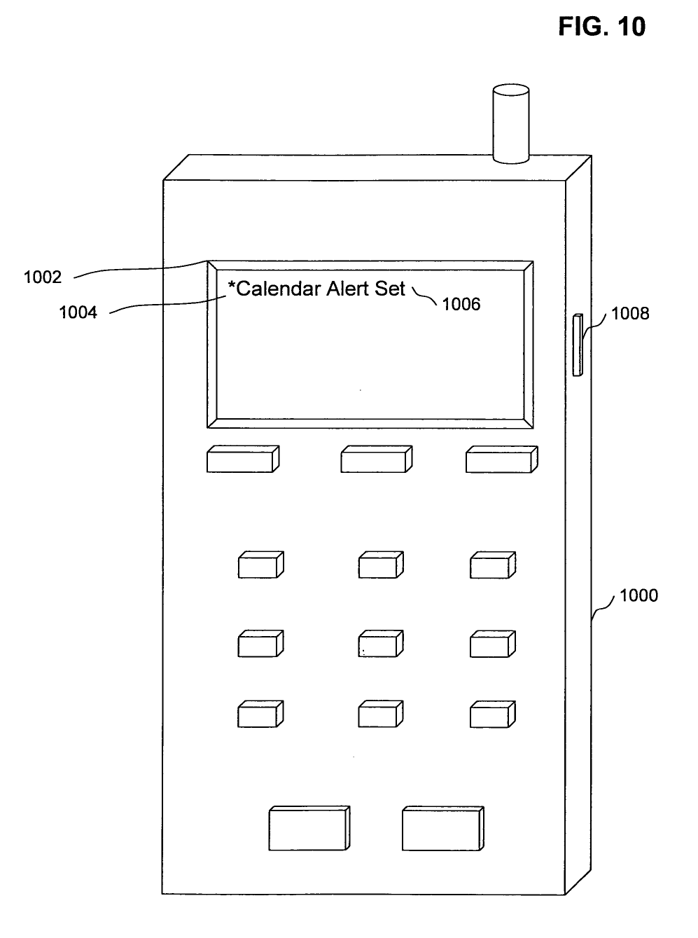

FIG. 10 is a pictorial representation of an example wireless device in accordance with various embodiments of the present invention. In these embodiments, wireless device 1000 performs the functions of host device 100. Display 1002 includes an icon 1004 and text 1006 that indicate that the calendar alert function is enabled. Alternatively, Display 1002 includes an icon and text (not specifically shown) that indicate that the calendar alert function is disabled. Further, wireless device 1000 includes a dedicated button 1008 for alternately enabling and disabling the calendar alert function.

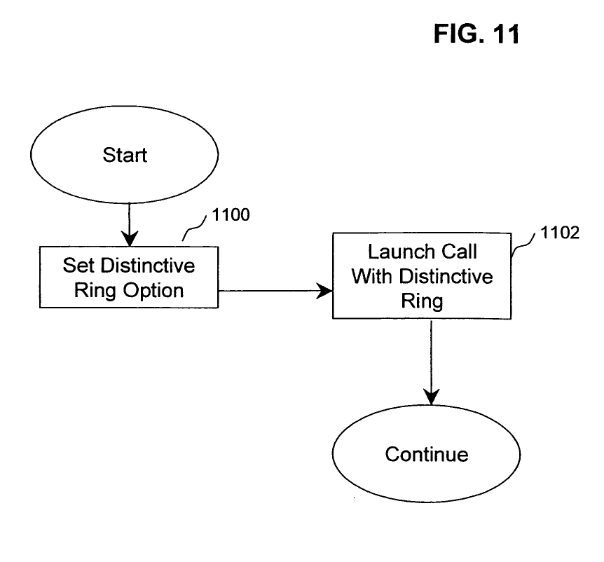

FIG. 11 is a flowchart representation in accordance with various embodiments of the present invention. In these embodiments, the step of launching a call or sending a telephonic alert includes accompanying the call with a distinctive ring. For the purposes of this disclosure, a distinctive ring is a feature where a different ring tone, cadence or pattern (such as “short-long-short”) is implemented for a particular call. In this fashion, the called party, when hearing the distinctive ring can associate the call with a particular event such as the calendar alert.

The method begins in step 1100 by setting a distinctive ring option. In a particular embodiment, this is implemented by the user selecting a distinctive ring, either globally for all calendar reminder events, or for a particular calendar reminder event. The method proceeds to step 1102 where the call is launched with the distinctive ring.

In one embodiment, the distinctive ring is implemented by choosing a telephone number associated with the called party that corresponds to a distinctive ring. This embodiment works well if the called party is the user, since the user can implement the distinctive ring feature through her telephone service provider, obtain a separate number corresponding to the distinctive ring and then assign that telephone number to the calendar reminder event or globally to all calendar reminder events.

In an alternative embodiment, a distinctive ring is implemented for a called party, distinct from the user. In this embodiment, a session initiation protocol (SIP) is used to provide information to an element of the advanced intelligent network such as a service control point (SCP). Before a call is launched, the host device 100, acting as a SIP user agent, registers with a service node intelligent peripheral (SNIP). In particular, a SIP message containing a SIP register command is sent to the SNIP over a data network such as the Internet. The SNIP, acting as a SIP Registration Server forwards the SIP register command to the SCP, acting as a SIP user agent server, via a data connection between the SNIP and the SCP, such as a corporate intranet. The SCP then optionally acknowledges the registration message to the host device through the SNIP. The SCP further, waits for a telephone call initiated by the host. When the acknowledgement is received by the host device 100, a call is launched on the public switched telephone network to the local service switching point (SSP) at the user's local central office. The SSP launches a query to the SCP that includes the calling party and called party telephone numbers. The SCP recognizes the call as requiring a distinctive ring, from the earlier registration of the host device 100 with the SCP, and forwards routing instructions for the call that include a designation for a distinctive ring. When the call reaches the called party the distinctive ring is implemented.

In a particular embodiment, the method ends by the host device 100 revoking its SIP registration with the SCP through the SNIP, either after a response is received by the most device to the call or after the call attempt fails through either a busy or no answer condition.

In a further embodiment, the distinctive ring feature is implemented for a local telephony device 110 in communication with the host device 100. The distinctive ring can be implemented by the generation, in the host device 100, of a distinctive ring signal that is transmitted to the local telephony device 110. This distinctive ring signal can be an audio signal that is played by the local telephony device 110 to implement the distinctive ring. Alternatively, the distinctive ring signal can include a command that, when executed by the local telephony device 110, implements the distinctive ring.

While various embodiments of the present invention have been presented in terms of telephonic alerts and sending messages through ordinary telephone calls, these embodiments likewise apply to text, audio, or video messaging sent via one or more data networks, and vice versa, within the broad scope of the present invention.

While various embodiments of the present invention present telephonic alerts in terms of ringing of the telephone, likewise, other form of telephonic alerts including, lights, message indicators, and other visual display could likewise provide the basis for the alert.

While various embodiments of the present invention disclosed herein contemplate the use of alerts that include pre-recorded messages, other forms of messages including text-to-speech generated messages, user recorded messages, or combinations thereof can likewise be used within the broad scope of the present invention. Similarly, alerts based solely on a telephone ring-tone, without a message can be employed.

Based upon the herein-disclosed high-level description, one or more computer programs to direct one or more computers to perform the methods disclosed is within the skill of a routine person in the art of telecommunications.

Embodiments of the herein-disclosed methods may be directed by computer-readable instructions encoded on a computer-readable medium. The contents of the computer-readable medium cause at least one computer to perform the herein-disclosed acts. For this purpose, at least one computer processor is responsive to the contents of the computer-readable medium. Examples of the computer-readable medium include, but are not limited to, a computer-readable storage medium and a computer-readable communication medium. Examples of a computer-readable storage medium include, but are not limited to, an optical storage medium, an electronic storage medium, and a magnetic storage medium. The computer-readable storage medium may include stored data, which encode computer program code and/or other computer-readable instructions.

Examples of a computer-readable communication medium include, but are not limited to, an optical communication medium, an electronic communication medium, and an electromagnetic communication medium. The contents of the computer-readable communication medium may include one or more waveforms that encode computer data such as computer program code and/or other computer-readable instructions.

It will be apparent to those skilled in the art that the disclosed emodiments may be modified in numerous ways and may assume many embodiments other than the particular form specifically set out and described above. Accordingly, it is intended by the appended claims to cover all modifications of the invention that fall within the true spirit and scope of the invention.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for use with an electronic calendar for issuing alerts, the method comprising:
detecting a calendar reminder event, the calendar reminder event having associated calendar event data;
launching a first telephone call to a first telephone number associated with the calendar reminder event in response to said detecting, the first telephone number associated with a first called party; and
sending a first message within the first telephone call.

2. The method of claim 1 further comprising:
determining that a telephone notification option is enabled.

3. The method of claim 1 wherein the first message comprises an audio message.

4. The method of claim 1 further comprising the step of:
receiving a first response from the first called party.

5. The method of claim 4 further comprising the step of:
determining if the first response is a valid response.

6. The method of claim 4 further comprising the step of:
determining if the first response is a cancel response.

7. The method of claim 4 further comprising the step of:
determining if the first response is a snooze response.

8. The method of claim 4 further comprising the step of:
determining if the first response is a reschedule response.

9. The method of claim 8 further comprising the step of:
scheduling a second telephone call.

10. The method of claim 4 further comprising the step of:
determining if the first response includes a request for more information.

11. The method of claim 10 further comprising the step of:
playing a second message, wherein the second message includes at least a portion of said associated calendar event data.

12. The method of claim 1 wherein the first message includes at least a portion of said associated calendar event data.

13. The method of claim 1 wherein the first telephone call includes a distinctive ring.

14. The method of claim 1 further comprising the step of:
retrieving the first telephone number.

15. The method of claim 14 wherein the step of retrieving the first telephone number includes retrieving the first telephone number from a list that includes one or more telephone numbers.

16. The method of claim 14 wherein the first telephone number has an associated distinctive ring.

17. The method of claim 14 wherein the step of retrieving the first telephone number includes the step of:
determining if an escalation option has been enabled.

18. The method of claim 14 wherein the step of retrieving the first telephone number includes retrieving the first telephone number from a list that includes one or more telephone numbers based on one or more escalation procedures.

19. The method of claim 1 further comprising the step of:
determining if a non-telephone alert has been issued at some prior time.

20. The method of claim 19 wherein the step of launching a first telephone call is performed if a non-telephone alert has been issued at a prior time.

21. The method of claim 19 wherein the step of launching a first telephone call is performed if a non-telephone alert has been issued at a prior time and a cancel response has not been received from the first called party.

22. The method of claim 19 wherein the step of launching a first telephone call is performed if a non-telephone alert has been issued more than a predetermined number of times.

23. The method of claim 1 further comprising the step of:
issuing a non-telephone alert.

24. A method of creating a calendar alert table for use with an electronic calendar, the method comprising the steps of:
prompting a user to enter first alert data;
receiving the first alert data from the user;
prompting a user to enter second alert data;
receiving the second alert data from the user; and
forming a calendar alert table from the received first alert data and the received second alert data;
wherein, the calendar alert table is accessible by the electronic calendar for generating a first alert in response to a calendar reminder event.

25. The method of claim 24 wherein the calendar alert includes a first alert that is generated based on the first alert data.

26. The method of claim 25 wherein the first alert includes a telephone call and the first alert data includes a corresponding telephone number.

27. The method of claim 25 wherein the first alert includes an SMS message and the first alert data includes a corresponding SMS message address.

28. The method of claim 25 wherein the first alert includes an email message and the first alert data includes a corresponding email address.

29. The method of claim 24 further comprising the step of:
receiving priority data from the user, the priority data indicating a priority order for selecting either the first alert data or the second alert data for generating the calendar reminder event.

30. The method of claim 24 further comprising the step of:
receiving conditions data from the user, the conditions data for selecting either the first alert data or the second alert data for generating the calendar reminder event.

31. A system for use with a host device for providing notification of a calendar event, the host device including an electronic calendar module, the system comprising:
a ringer alert module, in communication with the electronic calendar module for detecting a calendar reminder event, the calendar reminder event having associated calendar event data, and for launching a first telephone call to a first telephone number associated with the calendar reminder event in response to said detecting, the first telephone number associated with a first called party.

32. The system of claim 31 wherein the host device is a wireless telephone.

33. The system of claim 31 wherein the host device is a personal digital assistant.

34. The system of claim 31 wherein the host device is a computer.

35. The system of claim 31 wherein the telephone call is a placed over a voice-over-Internet-Protocol network.

36. The system of claim 31 wherein the ringer alert module further sends a first message within the first telephone call and is capable of receiving a first response from the first called party.

37. A system comprising:
a telephony device associated with a computer system;
an electronic calendar module; and
a ringer alert module, in communication with the electronic calendar module and the telephony device, for detecting a calendar reminder event and for generating and transmitting a ring alert signal to the telephony device.

38. A method for use with an electronic calendar for issuing alerts, the method comprising:
detecting a calendar reminder event, the calendar reminder event having associated calendar event data;
determining that a telephone notification option is enabled;
if the telephone notification event is enabled, launching a first telephone call to a first telephone number associated with the calendar reminder event in response to said detecting, the first telephone number associated with a first called party;
sending an audio message within the first telephone call, the audio message including one or more of the calendar event data;
receiving a first response from the first called party;
determining if the first response is a valid response;
determining if the first response is either a snooze response or a reschedule response; and
scheduling a second telephone call based on the first response.

39. The method of claim 38 further comprising the step of:
retrieving the first telephone number.

40. The method of claim 39 wherein the step of retrieving the first telephone number includes retrieving the first telephone number from a list that includes one or more telephone numbers.

41. The method of claim 40 wherein the step of retrieving the first telephone number includes the step of:
determining if an escalation option has been enabled.
